(19) United States
(12) Patent Application Publication
(10) Pub. No.: US 2013/0179359 A1
(43) Pub. Date: Jul. 11, 2013

(54) SYSTEM AND METHOD FOR JOB SAFETY ANALYSIS

(71) Applicants: James K. Burns, New Castle, NH (US); Randall D. Decker, Pearland, TX (US)

(72) Inventors: James K. Burns, New Castle, NH (US); Randall D. Decker, Pearland, TX (US)

(73) Assignee: PSC INDUSTRIAL OUTSOURCING, LP, Houston, TX (US)

(21) Appl. No.: 13/402,343

(22) Filed: Feb. 22, 2012

Related U.S. Application Data
(60) Provisional application No. 61/584,400, filed on Jan. 9, 2012.

(51) Int. Cl. G06Q 99/00

(52) U.S. Cl. 705/325

(57) ABSTRACT

The invention generally relates to job safety analysis and systems for implementing job safety analyses. In certain aspects, the invention provides systems and methods for job safety analysis which includes one or more portable electronic devices configured to identify all participating workers and guide them through a thorough a job safety analysis review (JSA review) while also supplying captured information to a database in support of a JSA program.

### RELATED APPLICATION

The present application claims the benefit of and priority to U.S. provisional application Ser. No. 61/584,400, filed Jan. 9, 2012, the content of which is incorporated by reference herein in its entirety.

### FIELD OF THE INVENTION

The invention generally relates to job safety analysis and systems for implementing job safety analyses.

### BACKGROUND

Labor statistics show that there were more than 3 million injuries and illnesses in 2009 and 4,551 fatalities in the workplace in 2009. Workplace injuries and fatalities can be highly traumatic and distressing to those who suffer from them and organizations are always seeking ways to improve safety. Job safety analysis (JSA) is a method of improving safety involving a review of job hazards whenever a job is performed.

A JSA review is implemented by providing a paper form on which the job is broken down into steps. A person then identifies hazards associated with each step, and makes a recommendation to mitigate the hazards. The recommendations are then implemented. The JSA review can be part of a larger JSA program in which the paper forms are meant to be made available to future workers on that job. However, paper JSA forms are often filled out poorly, if at all.

Even in heavy industry, employees are known to rush through the JSA forms. Refineries and utility plants, for example, require the completion of a JSA form before the start of a job, and these organizations acknowledge problems using the current paper form system. For example, employees often quickly fill in the blanks of a JSA form without real thought. This careless and perfunctory approach has come to be called “pencil whipping.” Pencil whipping is a significant obstacle to making workplaces safer because such perfunctory efforts do little to actually identify hazards and corrective measures.

Further, problems with paper JSA forms arise when different entities collaborate. For example, a corporation may hire an outside service provider to oversee a job. The service provider may hire subcontractors who then perform different parts of the job. A representative from the corporation may be involved at each step, for instance to provide plant access. In such complex cases, it can be difficult to ensure that every worker contributes to a JSA review. Also, valuable insights and information held in one company's JSA forms will not be shared with others.

Paper forms pose problems to JSA reviews. Workers may not read and pay attention the material. Handwriting can be illegible or incomplete. Paper JSA forms suffer from limited space, which encourages employees to stop when they have run out of room, as opposed to giving a comprehensive evaluation. Paper JSA forms don't provide job-specific incident histories. Safety manuals are often locked away in an office. Complacency and repetitive tasks lead to low quality hazard reviews. Often, a JSA review is done only by a designated “JSA writer”, usually the worker with the best command of the English language. This can lead to little or no participation by the other crew members.

Paper forms often do not show who worked on a job. A worker may not put their name on a form or may have bad handwriting. That worker may be an employee of a subcontractor and their name may not appear in any contractor records.

Paper forms create language problems. If a worker is not literate in the language of the form, valuable information will be lost. Furthermore, many people can communicate well orally, but find themselves at a loss when writing. Thus, in some situations, there is job hazard information which goes unrecorded even though there is a worker who is perfectly capable of describing it.

Paper JSA review forms can be difficult to integrate into a JSA program. Over time, information about hazards and best practices accumulates in the paper forms. Analysis of this data could reveal patterns associated with the hazards. Accordingly, companies would like to collect the information in their JSA forms for training and planning. Further, JSA information may be useful for after-the-fact accident/incident investigation. For example, if a worker is injured, a company may want to know whether the worker was, in-fact, at that job site or was given certain safety instructions.

Unfortunately, paper JSA forms are often lost, misfiled or degraded to the point where review for trending, coaching, or praise is difficult. Even with frequent management job audits, it is difficult to ensure that JSA forms are filled out before the job begins and not sometime afterwards. Metric analysis and reporting can be labor intensive due to manual data entry and chart building.

### SUMMARY

The invention provides systems and methods for job safety analysis which includes one or more portable electronic devices configured to identify all participating workers and guide them through a thorough a job safety analysis review (JSA review) while also supplying captured information to a database in support of a JSA program. The portable electronic device is configured to record information about hazards associated with each step of the job and to deliver safety recommendations for those hazards. The device can then present one or more questions about a hazard and capture responses to the questions provided by the person. The device can be configured to receive information, identify a participant, require an input before advancing, or share information with computers, databases, and other devices.

Systems of the invention can include a database. The database can receive and store information about hazards from the electronic device or devices. Hazard information can include, for example, what measure may mitigate the hazard (e.g., necessary personal protective equipment (PPE), evacuation route, or location of a safety shower); a historical event; a condition of the environment, structures, or materials. The invention provides programs for analyzing that information and identifying patterns associated with the hazards that workers face.

In certain aspects, the invention provides a system for ensuring safety, the system including a portable electronic device containing a memory, the device being configured to capture information that uniquely identifies a person and further including a data file, stored in the memory, containing information identifying a first step of a job to be performed; an input tool configured to capture hazard information associated with the first step of the job and store the hazard information in the data file; and an output mechanism operably engaged with the portable electronics device and configured to deliver a safety recommendation relating to the hazard.

The system may further include a database communicatively coupled to the memory, the database being configured to receive and save data from the data file and additional data from a second data file; and a computer processor operably engaged with the database and configured to analyze the saved data and the saved additional data and produce an output file including a hazard pattern.

The invention optionally provides a second device configured to receive alert information and substantially immediately transmit the alert information to the portable electronic device, and in which the portable electronic device is further configured to report the alert information to the person. The alert may be received and transmitted by a server device or a second portable electronic device. A data file can be written to include information identifying the identity of a job to be performed, a step of a job to be performed, a second step of a job to be performed, a participant, a hazard, or a mitigation step for a hazard. A communication module can be used to send part of a data file from the portable electronic device to a second portable electronic device.

In certain embodiments, the computer processer or portable electronic device is further configured to provide a metric associated with the capturing of information by the portable electronics device. In certain embodiments, the metric includes one selected from the lists consisting of: an duration of a process; an identity of a participant; a size of a portion of the data file; a time of a computer interaction; a location of a computer interaction; information about a non-compliant event; an estimated cost associated with one or more JSA reviews.

Systems of the invention can include a personnel tag uniquely associated with the person and in which the portable electronic device is further configured to electronically determine a location of the personnel tag. Devices of the invention can use a status indicator to indicate a status of the person and change, responsive to the output mechanism delivering the safety recommendation, the status of the person.

Devices can include input and output tools, including one or more of a microphone, keyboard, mouse, touchscreen, pointer, speaker, screen, and noisemaker. Systems of the invention optionally include a transcription module configured to create a text file based on a sound file.

In certain aspects, the invention provides a method for ensuring safety, the method including performing, by means of a computer system, the steps of: providing a portable electronic device at a site where a job is to be performed, the portable electronics device including a memory, the memory including a data file; recording, in the memory, information that uniquely identifies a person at the site where a job is to be performed; capturing hazard information associated with a first step of the job to be performed; saving the hazard information in the data file; and delivering, by means of the portable electronic device, a safety recommendation relating to the hazard to the person at the job site.

Methods of the invention include the steps of transferring data from the data file to a database; transferring additional data from a second data file to the database; and analyzing, using a computer processor in communication with the database, the data and the additional data to produce an output file including a hazard pattern. Capturing hazard information can further include receiving and storing one selected from the list consisting of: keyboard strokes; a digital picture, a fingerprint image, touch-screen input data, accelerometer input data, and a sound recording of human speech. A safety recommendation can be delivered via playing sound through a speaker, displaying data on a screen, and playing an noise using a noisemaker. In certain embodiments, the delivering a safety recommendation further includes the steps of accessing a text string stored in the data file and converting the text string into a sound of human language corresponding to the text string.

Methods include indicating a status of the person by means of the portable electronic device and changing, after recording the information that uniquely identifies a person, the status of the person. A review status can be established, for example, as incomplete, to cause a JSA to be reviewed. Methods further include setting the review status to incomplete and changing, only after one or more of the other steps is complete, the review status to complete.

In certain embodiments, methods of the invention further include the steps of capturing a sound of human speech in real-time and creating a readable text file corresponding to the sound of human speech.

In certain aspects, the invention provides an apparatus containing a memory and configured to capture information that uniquely identifies a person and further including a data file, stored in the memory, containing information identifying a first step of a job to be performed and, optionally, information identifying a second step of a job to be performed; an input tool configured to capture hazard information associated with the first step of the job and store the hazard information in the data file; and an output mechanism configured to deliver a safety recommendation relating to the hazard. An apparatus of the invention further includes a data transfer mechanism configured to send data to a database.

The apparatus may include a microphone, a transcription module configured to convert voice to text, a data transfer mechanism configured to send part of the data file to a portable electronic device, one or more apps configured to communicate information pertaining to a hazard, a speaker, or a read-aloud program configured to convert a text string into a sound of language corresponding to the text string.

The invention provides a system for conducting a JSA in the context of a safety program which includes an electronic device which engages a worker in a JSA review.

### BRIEF DESCRIPTION OF THE DRAWINGS

FIG. 1 is a perspective view of a portable electronic device according to one embodiment of the invention.

FIG. 2 is a view of a portable electronic device displaying a job safety analysis on a screen according to one embodiment of the invention.

FIG. 3 is a block diagram of a system for performing a job safety analysis according to one embodiment of the invention.

FIG. 4 is a flowchart of an exemplary process for conducting a job safety analysis according to one embodiment of the invention.

FIG. 5 is a flowchart of an exemplary process for conducting a job safety analysis according to one embodiment of the invention.

FIGS. 6-20 are screen displays shown on a screen of a portable electronic device according to certain embodiments of the invention.

### DETAILED DESCRIPTION

The invention provides a system for job safety analysis, in which systems and methods of the invention ensure improved employee participation, improved hazard recognition, and improved hazard elimination or mitigation, resulting in fewer injuries. In certain embodiments, the invention includes a portable electronic device containing a memory.

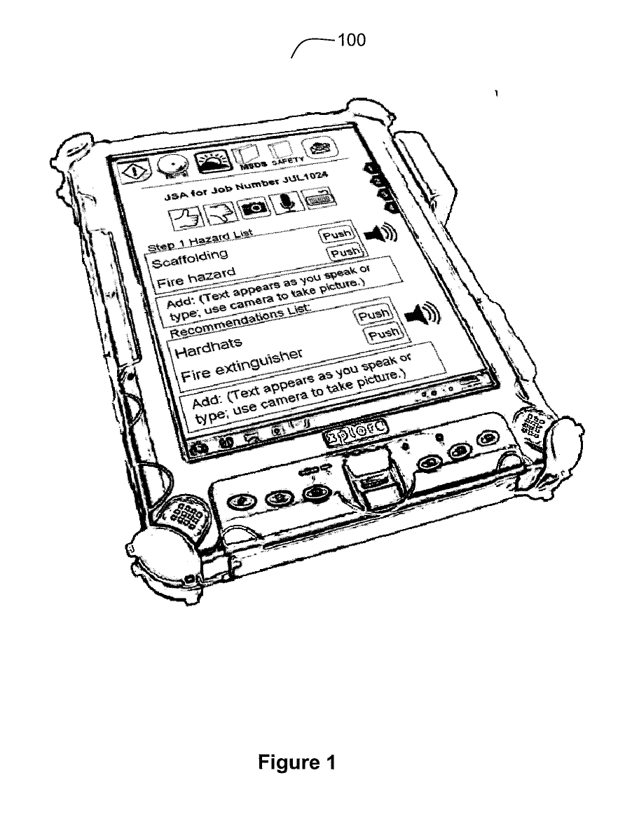

FIG. 1 shows a device 100 which provides the portable electronic device in certain embodiments. Device 100 is configured to have a data file stored in its memory corresponding to a job to be performed. The file can be a previously completed job safety analysis file, a blank job safety analysis file, for example, with a data structure corresponding to the steps of the job to be performed, or a blank file which gets created as a worker first performs a job safety analysis.

Device 100 is generally a portable electronic computing device. In certain embodiments, systems of the invention include one or more of device 100. In certain embodiments, each device 100 may or may not be of the same make and model or same general category of electronic device. Categories of electronic device from which device 100 can be chosen include laptop computers, tablet computers, ruggedized laptops, custom-designed devices, handheld devices, and smartphones. In certain embodiments, the portable electronic device is an Xplore ix104c3, a Motorola MC70, or an iPad.

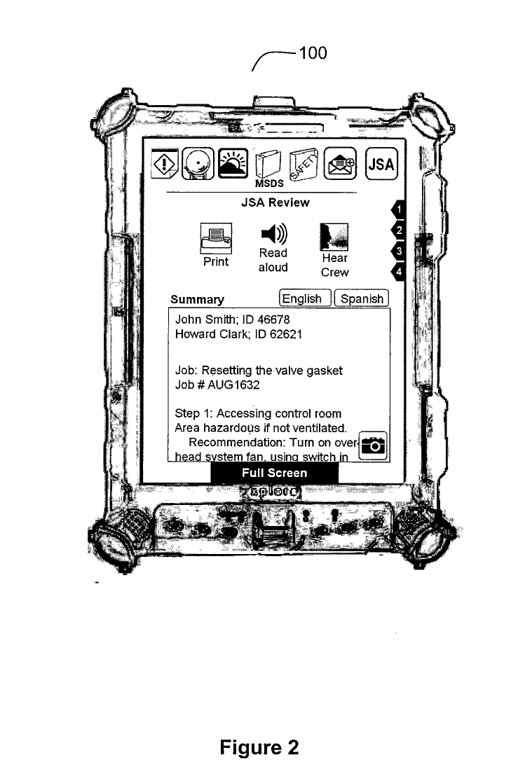

Device 100 generally has at least one input tool and at least one output mechanism. Suitable input tools include a keyboard integrated into the device, a keyboard attached to the device, a touch screen, a keyboard area displayed on a touch screen, a mouse, a microphone, a data connection, and an accelerometer. Suitable output mechanisms include a screen, a speaker, a noise maker such as a bell or buzzer, a data connection and a headphone jack. FIG. 2 shows device 100 having as an output mechanism a screen, and displaying part of a completed JSA on the screen. FIG. 2 further shows device 100 having as a input tool a touch screen, such that a person can touch a read aloud icon to hear the text read aloud or a full screen button, for example, to read the JSA on the full screen.

In certain embodiments, the portable electronic device has a data connection as an input tool, and is configured to receive, through the data connection, a set of global positioning system (GPS) coordinates from a GPS tag associated with a worker.

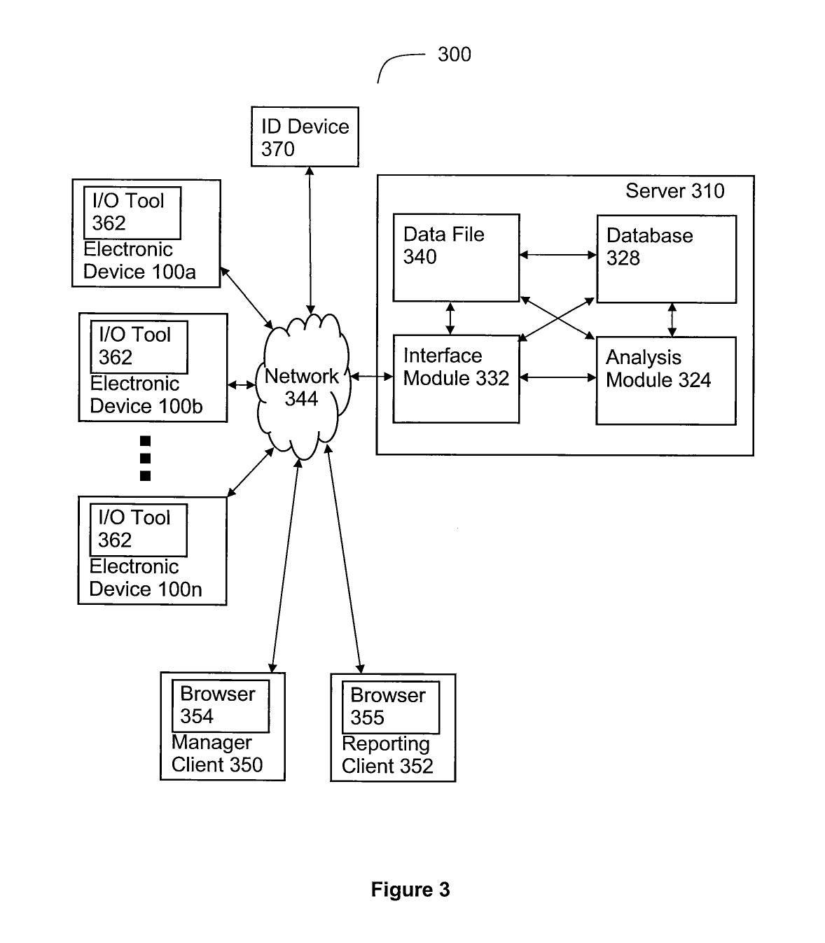

FIG. 3 shows a block diagram of a system according to one embodiment of the invention. According to one embodiment, the invention includes one of, or optionally a plurality of, portable electronic devices 100a, 100b, . . . 100n. Each device 100 is optionally communicatively coupled with a network 344. Also communicatively coupled with network 344 are optionally a server 310 and also optionally an ID device 370. Server 310 is also optionally communicatively coupled, via network 344, to a manager client 350 and optionally to a reporting client 352. Each of manager client 350 and reporting client 352 can be, for example, a computer, and each can include a browser 354, which could be, for example, Internet Explorer or Google Chrome. Each electronic device 100 includes at least one I/O tool 362 for at least either input or output. Server 310 can optionally include any of data file 340 transferred from a device 100; database 328 including data from a data file 340; an analysis module 324 to analyze data; or an interface module 332 to communicate with other system components.

In one embodiment, all of the steps of the invention are performed on device 100. In one embodiment, server 310 is housed within a portable electronic device 100. In an alternative embodiment, server 310 is located at an office and portable electronic device 100 is used at a job site.

In certain embodiments, a worker wears or carries an ID device 370. In certain embodiments, ID device 370 is a GPS tag which produces GPS coordinates and optionally a GPS tag code. These coordinates are transmitted via network 344 to a device 100. In one embodiment, device 100 also comprises a GPS tag, and produces and stores its own GPS coordinates. In one embodiment, device 100 is configured to compare its own GPS coordinates to a worker's GPS coordinates and determine if the worker is within a certain distance of the device 100. In one embodiment, device 100 is configured to uniquely identify a worker based on a GPS tag code.

In certain embodiments, ID device 370 is a tag that includes a radio frequency identification (RFID) tag or a barcode, such that the tag uniquely identifies a worker. In certain embodiments, device 100 includes an antenna to detect an RFID tag or a barcode scanner to scan a barcode, thereby allowing device 100 to capture information uniquely identifying a worker.

In certain embodiments, an input tool included in device 100 is a fingerprint scanner or sensor. Device 100 can be configured to receive a fingerprint and compare it to existing records to uniquely identify a worker or save it for future comparison to uniquely identify a worker. In certain embodiments, an input tool of the device is a microphone and the device is configured to record a worker's voice and save a voice file to be used to uniquely identify the worker.

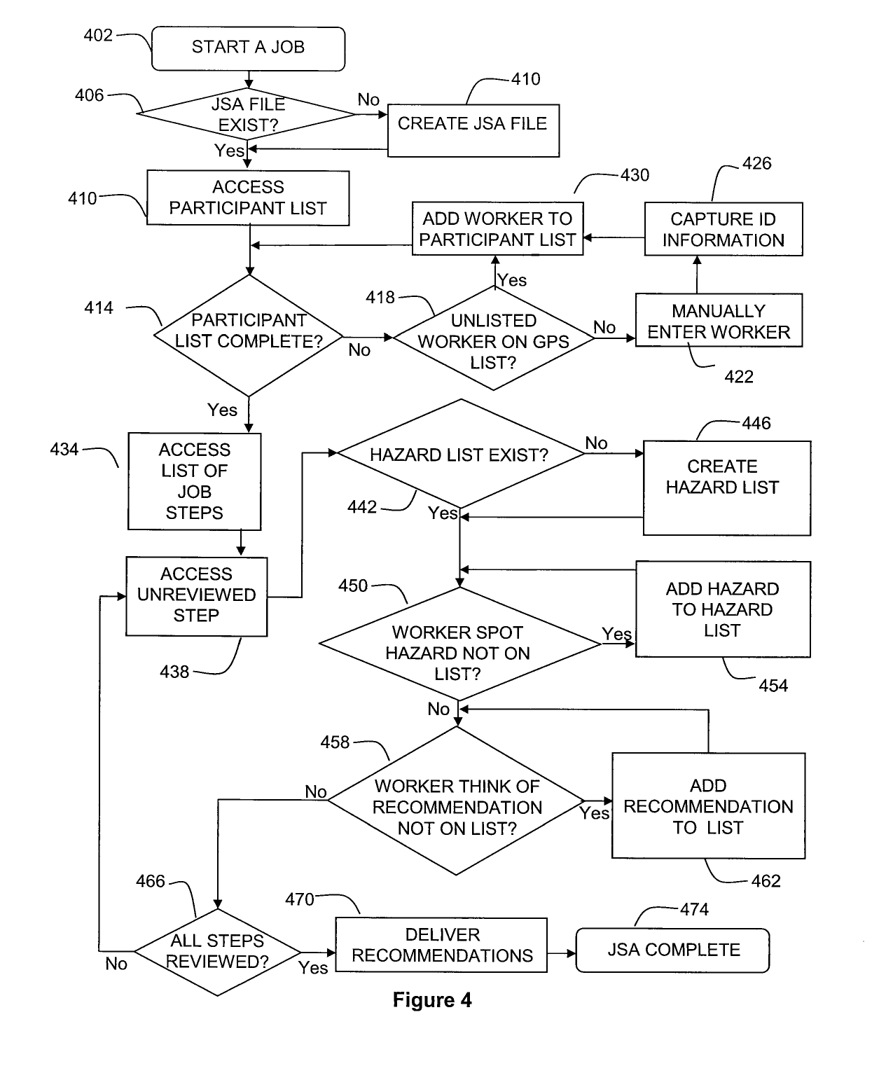

FIG. 4 is a flowchart of an exemplary process for conducting a JSA review according to one embodiment of the invention. In one embodiment, JSA review refers to a series of analytical steps performed by workers before beginning work on a particular job. In one embodiment, a JSA review is one step in a JSA program. According to one embodiment of the invention, a worker begins contributing to a JSA review at the start of a job 402.

In one embodiment of the invention, device 100 includes or is connected to a microphone and is configured to record sound. In one embodiment, device 100 records all conversation or talking by any workers throughout a JSA review. In this embodiment, at the first step of a JSA review in which a worker interacts with device 100, which can be, for example, choosing to perform a JSA review for a particular job, device 100 begins recording sound and records until the JSA review is complete. In one embodiment, device 100 has a sound-sensitive microphone and only records while people are speaking in the vicinity or other sound is being produced. In certain embodiments, the recording of sound begins at other steps, for example, while a worker is answering a question or reviewing a specific step of a job or when a worker turns on sound recording.

Once a JSA review is initiated, for example either as a new JSA from screen 800 or from a list of existing ones from screen 700, a worker will record the identity of the participating workers.

The first step of the job safety analysis according to one embodiment of the invention is to ensure that all of the workers who work on the job are correctly listed on the participant list in the JSA file. A worker uses device 100 to access 410 the participant list.

The worker ascertains 414 if the participant list correctly and completely lists every worker who actually appears at the job site to work. If the list is incomplete, the worker can ascertain 418 if a second worker who is actually at the job site also appears on the GPS list on device 100. If the second worker appears on the GPS list, the worker can use device 100 to add 430 the second worker to the participant list. If the second worker does not appear on the GPS list, the worker can manually enter 422 the second worker and capture 426 information which uniquely identifies the second worker. The uniquely identifying information can be a fingerprint, a code number, an RFID tag, a barcode, or a voice recording. After the identifying information is captured 426, the worker then adds 430 the second worker to the participant list. These steps are repeated until the participant list is complete.

The next step of the job safety analysis according to one embodiment of the invention involves viewing 434 a list of steps required to complete the job. For each step of the job, the worker creates or reviews 442 a list of hazards associated with that step. Any worker participating in the JSA review attempts to identify 450 as many associated hazards as possible and making sure they are all listed. Then, for each hazard, the workers make 458 any recommendations they can think of that would mitigate those hazards and add 462 those recommendations to the list. Once the workers have reviewed 466 all steps of the job, device 100 then delivers 470 recommendations to workers, thereby completing 474 these portions of the JSA review process.

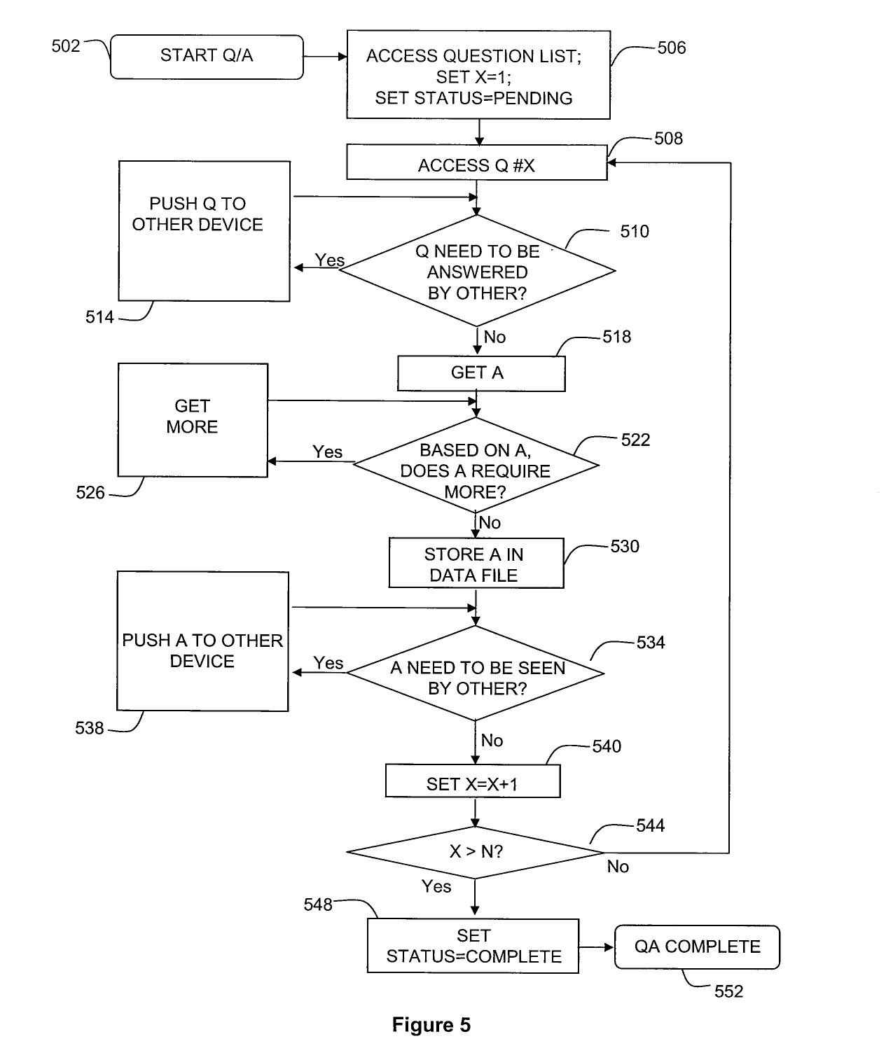

FIG. 5 is a flowchart of an exemplary process for conducting a job safety analysis according to one embodiment of the invention. The steps of FIG. 5 can be in addition to, or as an alternative to, the steps of FIG. 4. FIG. 4 generally describes a JSA review in a identify-hazard-and-recommendation (H/R) format. FIG. 5 generally describes a JSA review in a question-and-answer (QA) format. Certain embodiments of the invention use either, or both, or any combination of the two. Choosing a recommendation (i.e., determining mitigating requirements) is discussed in U.S. Pub. 2007/0250297, the contents of which are hereby incorporated by reference in their entirety.

A portion of a JSA review process begins 502 with a worker accessing 506 a list of questions relating to a job. In certain embodiments of the invention, the worker may optionally decide 510 to send 514 the question to other devices. In certain embodiments, the worker then answers 518 the question. In certain embodiments, certain answers can optionally cause 522 further information to be collected 526. The answer or answers are stored 530 in a JSA review data file. In certain embodiments, a worker may optionally decide 534 that an answer should be sent 538 to another device. Once the questions are determined 544 to have all been answered 548, these portions of the JSA review process are complete 552.

In one embodiment of the invention, the JSA review includes, for each step of the job, asking a series of questions associated with hazards, recording answers which provide information regarding or mitigating those hazards, and storing the answers to provide that information to a worker. Safety analysis is discussed in U.S. Pat. No. 6,741,951; U.S. Pub. 2005/0181337; and U.S. Pub. 2005/0149289, the contents of which are hereby incorporated by reference in their entirety.

In one embodiment of the invention, for example where there is only one device 100, the worker or workers will proceed to answer the questions until they are complete 552. In an alternative embodiment, for example where more than one device 100 is being used in connection with a JSA review, items may be “pushed” from one device to another.

In certain embodiments of the invention, any information stored in a memory of device 100 can be pushed to another device. For example, when device 100 outputs information, for instance by showing it on a screen or playing it through a speaker, device 100 can also display a button that, when pressed, causes the output information to be transmitted, via network 344 to another device. The other device can then incorporate that information into a JSA review.

In certain embodiments, device 100 will output a question for a worker to answer and the worker will ascertain 510 that the questions needs to be answered by a second worker using an second device 100b. The worker will then push 514 the question to second device 100b. Note that this process can be repeated for the same question. After pushing a question to second device 100b the worker may ascertain 510 that the question needs to be answered by a third worker using third device 100c. The worker will then push 514 the question to device 100c.

An answer is then provided 510 to device 100. The answer can be provided either by the worker answering the question or it can be pushed to device 100 from a second device 100b, or both.

In some embodiments of the invention, certain answers to certain questions will prompt device 100 to solicit 526 more information. For example, if a question is a yes-or-no question such as “does this step involve a fire hazard?”, an answer of “yes” can cause device 100 to prompt 526 the worker for a list of available fire equipment. In another example, a question may be “Would a picture be useful for describing a hazard?” In this example, if a worker answers “Yes,” it is ascertained 522 that device 100 should prompt 526 the worker to take a picture. In certain embodiments, device 100 has as an input tool a digital camera and device 100 can get 526 more information by means of having the worker take a digital picture which device 100 can then store 530 in a data file.

In one embodiment, device 100 is configured to get 518 answers or get 526 more answers by means of recording spoken answers or other sound and storing 530 the sound in a data file. In one embodiment of the invention, device 100 includes a voice-to-text (transcription) module and text-to-voice (read aloud) module. According to one embodiment, device 100 records spoken answers and converts the speech into text and stores the information in a text file.

Once an answer is stored 530 in a file on device 100, the worker may optionally be given the opportunity to ascertain 534 if the answer should be seen by a second worker using a second device 100b. If the worker decides that the answer should be shared with other workers, they can push 538 the answer to second device 100b. In like manner, device 100 can receive questions and answers pushed to it from second device 100b.

When a worker finishes answering a question, device 100 can increment 540 a question count variable and ascertain 544 if all questions have been reviewed. If not, device 100 can access 508 the next question. When all questions have been answered, device 100 can change 548 the status of the question list from pending to complete 552.

By means of the processes illustrated in FIG. 4 and FIG. 5 the JSA review can be completed and hazard information pertinent to each step of a job, as well as recommendations for mitigating the hazards, can be collected and saved to a data file, as well as shared with all workers who work on the job.

In certain embodiments of the invention, the JSA review is conducted according to the H/R format and the resulting data file includes a list of steps of the job and, for each step, information identifying a hazard associated with that step as well as a recommendation which, if implemented, will mitigate the hazard. In certain embodiments of the invention, the JSA review is conducted according to the QA format and the resulting data file includes a list of steps of the job and, for each step information associated with an answer to a question pertaining to a hazard as well as a recommendation which, if implemented, will mitigate the hazard. In certain embodiments of the invention, the recommendation is contained within the form of a question. For example, the question “Are there hardhats on-site?” is understood by the workers to include the recommendation to wear hardhats. As an alternative example, the question “Is a worker licensed to use the machine?” is understood by the workers to include the recommendation that the machine should be used by a licensed worker. In some embodiments of the invention, a yes or a no answer to a question contains hazard information associated with a step of the job. For example, the answer “Yes,” to the question “Are there hardhats on-site” supplies the information that hardhats are on-site. One skilled in the art will appreciate that this can be significant, for example, in cases in which a JSA review file is used again in a subsequent JSA review for the same job, as part of a JSA program or when two or more devices 100 are used simultaneously on a JSA review.

In one embodiment of the invention, when a company performs a job for a first time, i.e., a particular job that it has not performed before, the company will perform a first JSA review. All information collected during the first JSA review will be saved in a JSA review file. Subsequently, when a worker does that job in the future, when that worker performs the subsequent JSA review, the subsequent JSA review will include all information gathered during the first JSA review. Thus, according to this embodiment, if a first JSA review includes the yes-or-no question “Are there hardhats on-site?” and the first JSA review file includes the stored answer “yes”, then during the subsequent JSA review the worker will be given the information that hardhats are available on-site. Further, in certain embodiments, the later-participating worker will be asked the same questions and can also answer them independently, thereby adding to or updating the information in the JSA file, for instance if it has changed.

By having the JSA file sit in the context of a JSA program, a service company may collect up-to-date information and provide useful insights to each worker during each JSA review including insights arrived at by previous workers on other occasions.

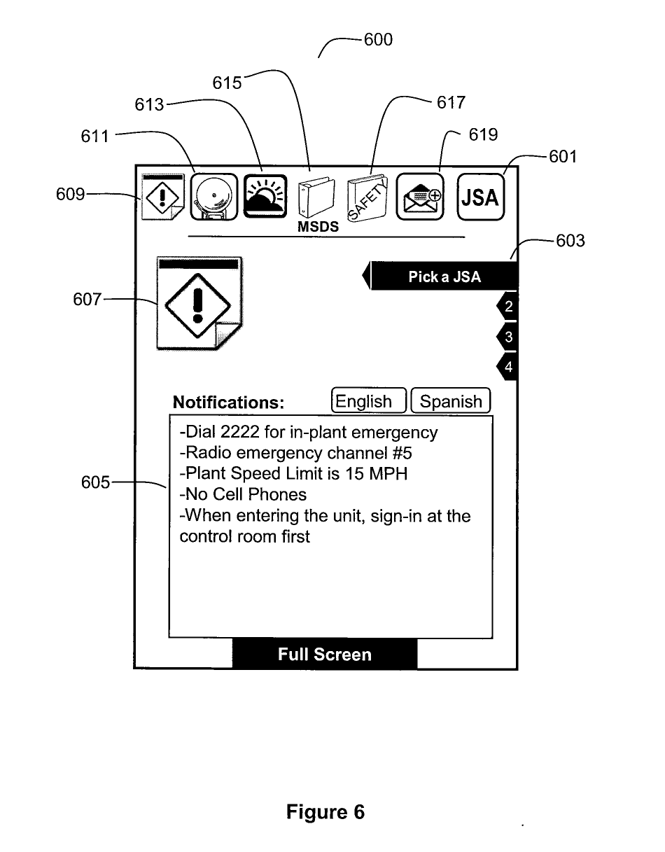

FIG. 6 shows a screen 600, which can be displayed on device 100. Screen 600 can be one form of a home screen, or default screen, of device 100, allowing a worker to access a number of tools or navigate to a number other screens.

In certain embodiments, one or more screens of the invention represents a form created in InfoPath or a web page, for example in XML, HTML, Flash, or HTML5 format. In certain embodiments, one or more screens are displayed by a web browser and includes navigation buttons common to web browsers. In certain embodiments, one or more screens are displayed by an application or an app. In certain embodiments, one or more screens includes navigation buttons that simulate those common to web browsers, regardless of the availability of a web browser program on device 100.

In certain embodiments of the invention, a screen 600 may display a toolbar across the top. In certain embodiments, screen 600 may optionally include a navigation area 603. The tool icons displayed can include a notification tool 609, an alarm tool 611, a weather tool 613, a material safety data sheet (MSDS) tool 615, a safety manual tool 617, a message tool 619, and a JSA tool 601.

In certain embodiments of the invention, a job safety system 300 includes a written computer program (i.e., written in C⁺⁺, Perl, Ruby on Rails, or another language), the program including modules. Modules of the program can provide functions, components, or tools of the invention. In certain embodiments, components or tools of the invention may be provided by apps (i.e., made with Java, Flash or another set of tools), including, for example, apps provided by outside parties. In certain embodiments of the invention, a tool of the invention can be provided by an app, and the app can be separately used or distributed independently. In certain embodiments of the invention, one or more functions of the invention are provided at least in part by a web site. One skilled in the art will recognize that modules and tools of the invention can be provided by a combination of apps, programming, and web sites. For example, in one embodiment, a service provider's web site supplies a log-in screen which requires an employee to provide unique identifying information in the form of a password; the use of personal protective equipment is illustrated by an app, for example written in Java; and the capture, transfer, and delivery of JSA data is provided by computer code and an SQL database.

In one exemplary embodiment of the invention, a worker may access a tool, for example, the notification tool 609. This can cause an associated tool display 605 to appear, as well as optionally a tool indicator 607. The display can be invoked, for example, by computer code provided by the invention or in the form of an app written with, for example, Java, Visual Basic, Java Script, or Python.

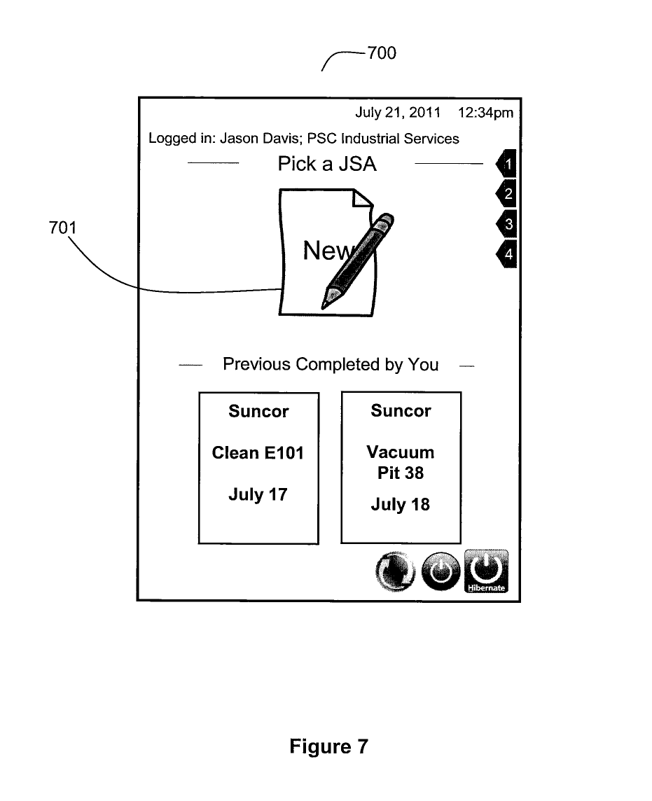

FIG. 7 shows a pick JSA screen 700 on which a worker can initiate a JSA review. The worker can select a job from a list of jobs or can enter a new job. If a JSA file does not exist in the memory of device 100, device 100 can create the file or optionally retrieve it from either server 310 or a second device 100b. If a desired JSA file is not listed, the worker can begin creating a new JSA review file, for example by touching the new JSA icon 701.

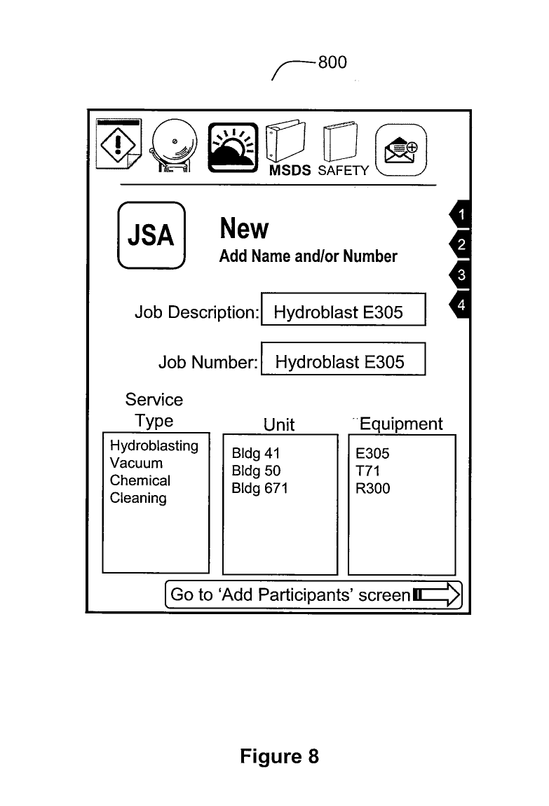

FIG. 8 shows a JSA settings screen 800 at which a worker can enter information pertinent to a new JSA review. In certain embodiments of the invention, when a worker chooses to begin a new JSA from a pick JSA screen 700, a JSA settings screen 800 is presented at which a worker can supply a job name or number. In certain embodiments, when a worker picks a job from a list from a pick JSA screen 700, a JSA settings screen 800 is displayed allowing a worker to confirm or edit settings associated with a job.

In certain embodiments, JSA review involves customized forms or screens. In certain embodiments, the JSA settings influence the customization of the forms.

A JSA settings screen 800 can allow a worker to filter a JSA form. For example, if a worker chooses a new JSA and then filters by Service Type and chooses Chemical, the new JSA form can be created to include questions and hazard lists relating to chemical hazards. For example, if a worker chooses a JSA and filters by Unit and chooses Bldg 41, any or all former JSA files associated with that filter can be linked, pushed, or displayed to the worker. In certain embodiments, a data table associates a setting with a property (i.e., in a one-to-one, one-to-many, or many-to-one relationship) and a custom form is employed relating to the property. For example, in a table, Bldg 1 can be linked to “asbestos” and “extreme cold”. Accordingly, a custom form can include material related to PPE or can invoke a PPE tool or app.

In certain embodiments, once a new JSA review is initiated, device 100 will begin to record sound.

In certain embodiments of the invention, once a JSA review has been initiated or set up, a worker will proceed to add the names and confirm the identities of all workers who will be participating in the job.

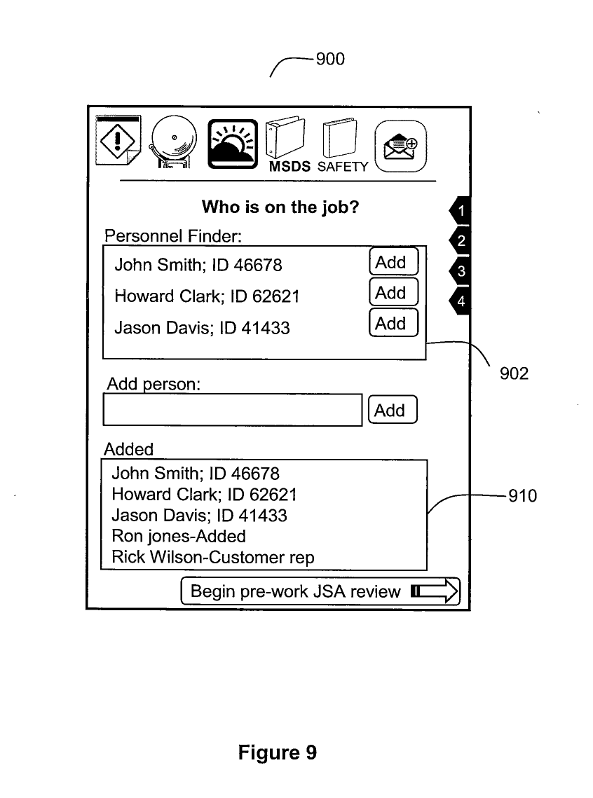

FIG. 9 shows an add participant screen 900 including a participant list 910. At the beginning of the JSA review, the participant list can list those workers who are scheduled to, or intended to, work on the job. A finder list 902 can display a list of people that the system has identified as being nearby. In certain embodiments, the system identifies nearby people based on GPS tags or RFID tags or other identifying tags worn by the people.

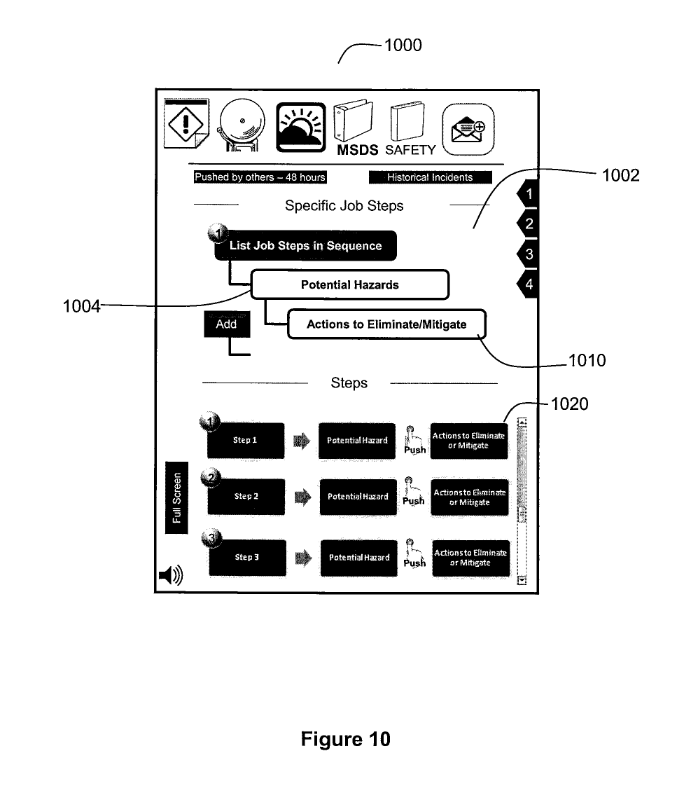

FIG. 10 shows a job overview screen 1000. A step view area 1002 appears on the screen, as well as a step list summary 1020.

In certain embodiments, a worker will, using device 100, access 434 a list 1020 of job steps (in some cases, a job will only include one step and the worker will access 434 a data file simply listing the job, i.e., as a single step).

The worker will then review each step in-turn, in a process that begins by accessing 438 each step from the list 1020. For each step, a worker can access a hazard list, for example by interacting with a potential hazard button 1004. For each hazard, a worker can enter a recommendation, for example by interacting with mitigate button 1010.

Step list 1020 shows the steps of a job sequentially, in a list. Step view area 1002 shows a step as a flow diagram or taxonomy. Job overview screen 1000 allows, for each step of a job, a potential hazard to be identified, and an action to mitigate that hazard to be identified. In certain embodiments, any screen of the invention, for example, job overview screen 1000, can display a button for “full screen” view, a speaker icon to cause text to be read aloud, scroll bars, and other user interface elements.

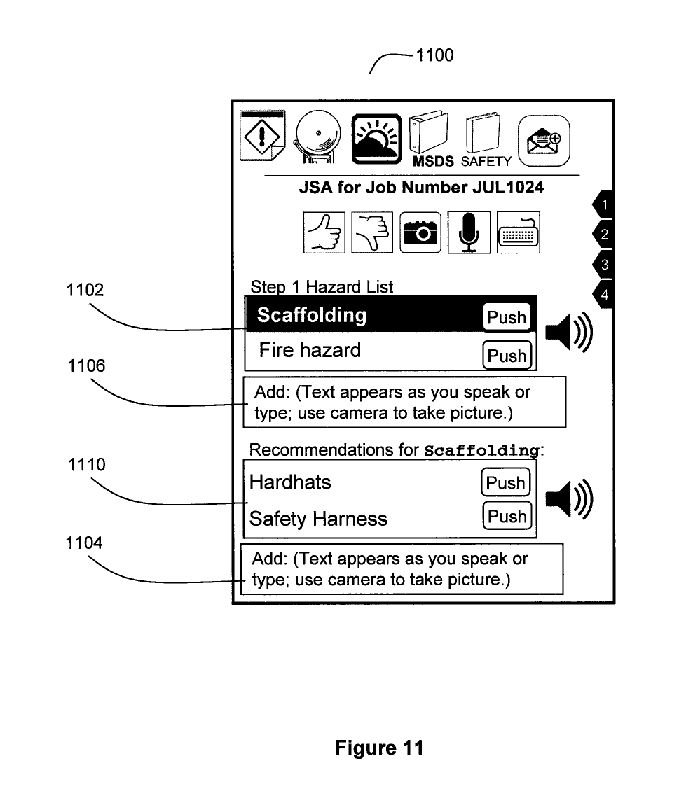

FIG. 11 shows a step detail screen 1100. For each job step, the worker ascertains 442 if a hazard list 1102 exists and, if not, creates 336 one. The worker and any other workers can then examine that step of the job, taking into consideration real-world conditions, their own knowledge and experience, as well as logic and inference, to spot 450 any hazards which are not yet listed. The worker then uses add hazard field 1106 to add 454 those hazards to the list 1102.

Then, for the hazards listed for a job step, the workers then think 458 of any actions which could mitigate those hazards. If those actions are not already on recommendation list 1110, the worker will then use add recommendation field 1104 to add 462 those the recommendations to recommendation list 1110.

Once all the steps have been reviewed 466 in this manner, the workers have a record containing a thorough and thoughtful review of the hazards associated with the job as well as recommendations to mitigate those hazards. At this point, device 100 can deliver 470 those recommendations back to the workers.

For each step or for each hazard, a worker can indicate a thumbs-up or a thumbs-down, using easily-recognized corresponding icons. Systems of the invention can capture these indications as hazard information. A worker can, in certain embodiments, take a picture, record sound through a microphone, or enter text by causing a keyboard to be displayed on a touch-screen, each through an easily-recognized corresponding icon.

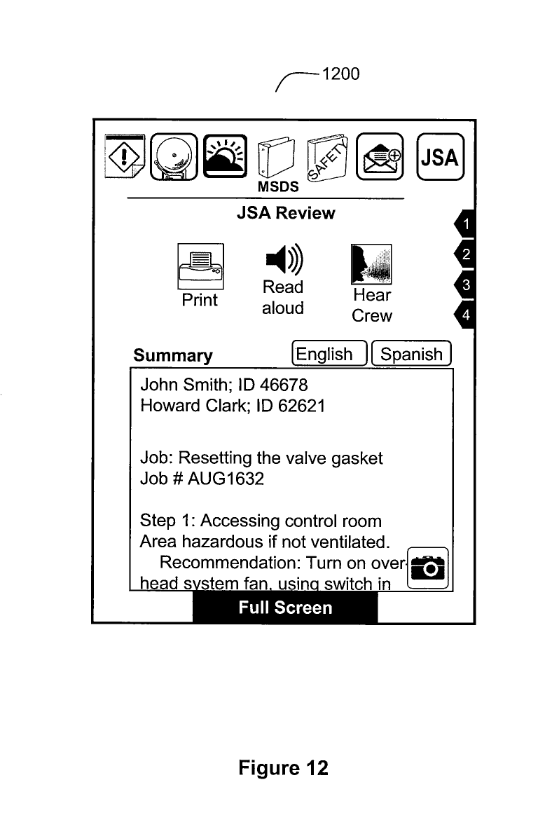

FIG. 12 shows a JSA review playback screen 1200 which a worker can use to play back the contents of a JSA, thereby making device 100 deliver 470 safety recommendations to workers.

For instance, if the workers typed their recommendations into device 100, they can now re-read their own typed recommendations. If recommendations were spoken near device 100, they can now be read aloud from a text file created by a transcription module or recorded sound file can be played back.

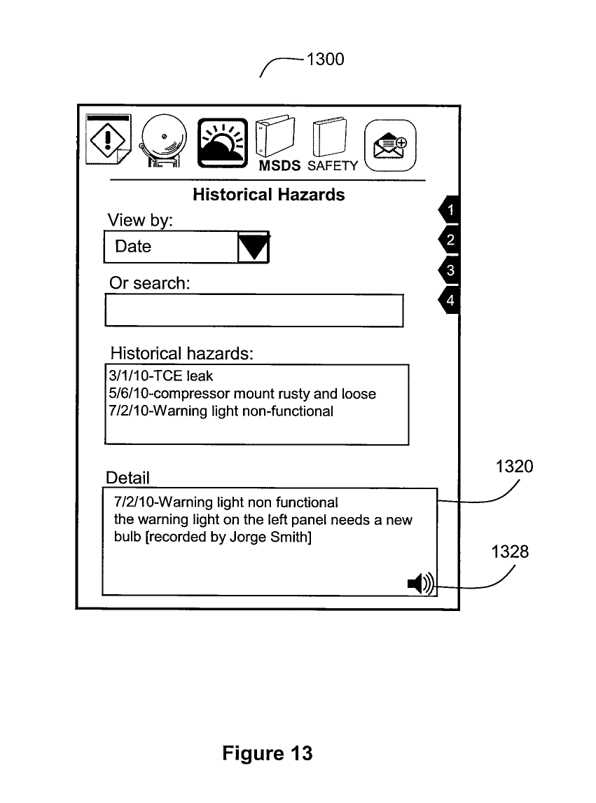

FIG. 13 shows a historical hazards review screen 1300 by which device 100 can capture or output safety recommendations relating to a hazard. Safety recommendations can be shown or entered on detail screen 1320 or can be caused to be played through a speaker or headphone jack output mechanism by means of audio play icon 1328. Audio playback can include playing sound produced by a read-aloud conversion of the text in detail screen 1320 or playing back an audio file previously recorded by a worker.

In certain embodiments of the invention, the delivery 470 of the recommendations can be in other modes than workers re-reading their own typing. For example, in one embodiment, the JSA file existed before the workers began the JSA process 400. In this embodiment, the JSA file already had some recommendations in it, and the workers add new ones. Device 100 then delivers 470 all of the recommendations together.

In another embodiment, workers are using more than one device 100 to work on a JSA collectively. One sub-group of workers puts in recommendations at one place and at one time, while another subgroup puts in other recommendations at another place and another time. This can happen, for example, when a single JSA is being completed for a complex, multi-step job. This can also happen, for example, with relatively simple jobs, but where workers from different companies are working together, but each using their own employer-provided device 100.

In one embodiment of the invention, a service company coordinates the efforts of one or more subcontractors who participate on a multi-step job. Each step of the job may be reviewed by one or more workers who come from any of a number of different employers. The service company provides at least one device 100 to be used at the review of each step of the job. Each device 100 collects the unique identifying information of each worker at each step and either writes this information to a single JSA file or synchronizes related files across one or more devices or stored on server 310. Thus, a worker at a first step of a job may identify that the step involves a fire hazard, for example. Also, a different worker, at a different step of the job, may record the recommendation that workers arm a fire-suppression system. By saving the input from each worker using each device to a single data file, or a plurality of duplicate data files, a single JSA is produced which includes all the analysis information provided by the workers. Then, when the system delivers 470 the recommendations, it is not simply delivering information back to a person who provided it, but is also sharing information new to workers who may benefit from it.

In certain embodiments, system 300 can deliver alerts. An alert can enter the system via a device 100; a client 350 or 352; by email for example through message tool 619; or through an app supplied to an outside party, for example through notification tool 609. Alerts can be triggered by a calendar, a weather condition accessed through weather tool 613, or responsive to a calculation or comparison of conditions on server 310. System 300 can deliver alerts in real-time or at a scheduled time. Real-time delivery can involve transmission and deliver substantially simultaneously with an origination of an alert within a part of the system. In certain embodiments, substantially simultaneously means instantaneously, for example, as transmitted over an open phone line or high-speed internet connection. In certain embodiments, substantially simultaneously means nearly instantaneously, for example, at the speed at which email is transmitted for example according to a simple mail transfer protocol.

The delivery 470 of the recommendations is optionally further accompanied by a full review of the JSA including a review of the participant list, the list of job steps, the hazard list and all the hazards listed thereon, as well as hazard pattern information, discussed in more detail below. After the JSA is reviewed, the JSA review is complete 474, and device 100 can optionally change the status of the workers who participated in the JSA review to indicate their participation.

In certain embodiments of the invention, a JSA review can not proceed beyond a given step until at least one worker, or each worker on a participant list, has participated. For example, in certain embodiments, each worker is initially given a status indicating not ready. In certain embodiments, as a worker completes a specified step of the JSA review, a system of the invention changes their status to indicate ready to proceed. In certain embodiments, a module of the invention will not proceed or run until each worker has a status indicating ready to proceed. In certain embodiments of the invention, a status of a worker is stored in a data file in a memory on device 100. In certain embodiments, a status of a worker or a JSA review is supplied to database 328 and used in managing, metrics, or reporting.

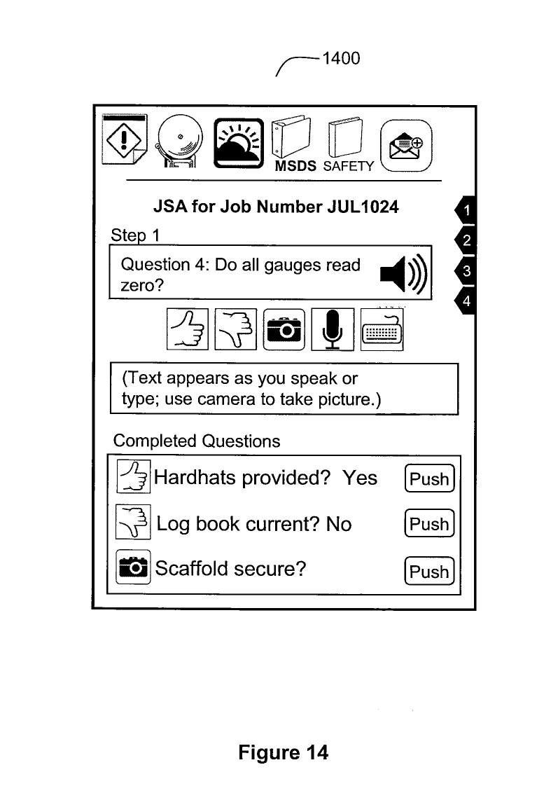

FIG. 14 shows a question step screen 1400 for prompting a worker to answer a series of questions associated with a step of a job. In certain embodiments, a JSA review proceeds by a series of questions and answers in a QA format. In another embodiment according to the invention, the JSA review involves first examining the steps of a job in H/R format, and then examining the readiness of the workers in QA format.

In certain embodiments, the JSA review proceeds via the H/R format but if certain hazards are identified, device 100 invokes a sub-review procedure in the QA format. For example, any industrial job may be reviewed using a general H/R format, but any time a worker identifies a fire hazard, a pre-set list of questions can be presented in QA format, in which the questions deal specifically with fire safety equipment.

In an alternative embodiment, every JSA review begins and ends in the QA format but when certain questions prompt specific answers, device 100 invokes a sub-review in the H/R format dealing with a specific aspect of the overall job.

In another embodiment of the invention, certain hazard categories are first reviewed, or separately reviewed, using their own series of questions, independently of the step-by-step review of the overall job. For example, a JSA review may first include a series of questions directed to the hazards and safety of the tools necessary for a given job, before proceeding to analyze the various hazards particularly associated with each step of the job.

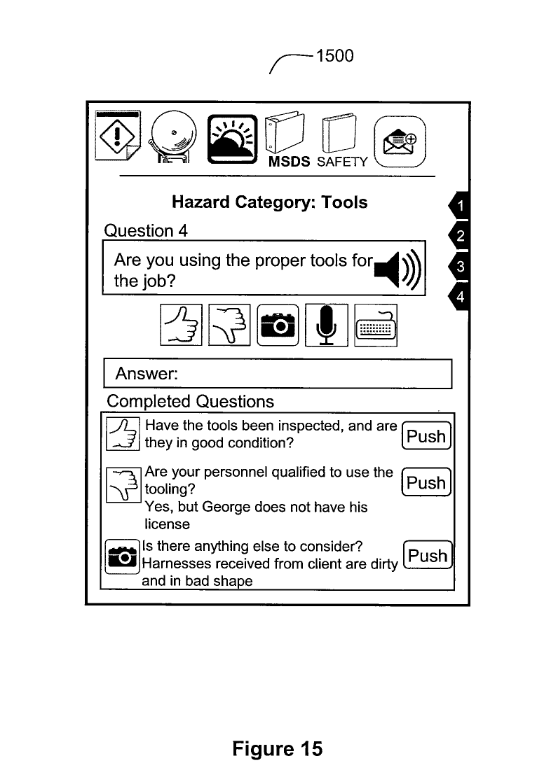

FIG. 15 shows a hazard category screen 1500 prompting a hazard category review according to one embodiment of the invention. When a review of a category of hazards or sub-review begins 502 to proceed according to the QA format, device 100 will access 506 a question list and access 508 the first question on the list and present it to the workers. In certain embodiments, the invention provides a hazard category review as an app. In certain embodiments, messages come in the form of alerts and get delivered (i.e., “pop up”) substantially simultaneously with their origination.

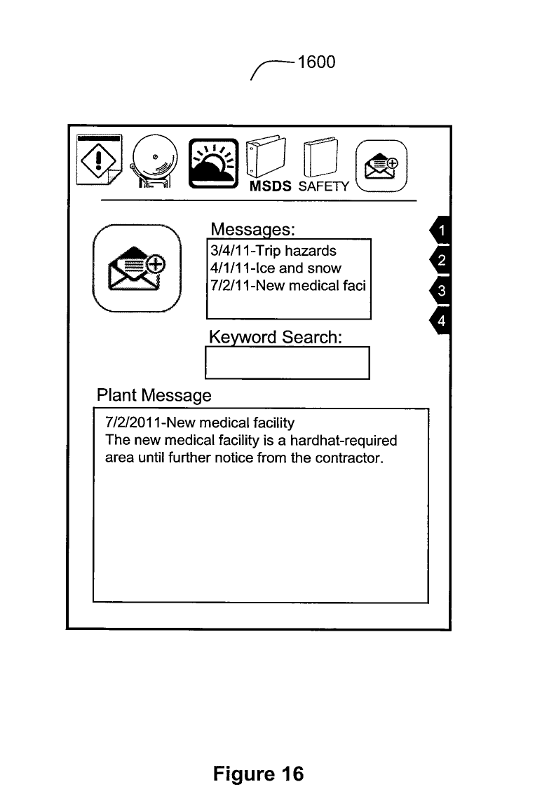

FIG. 16. shows a message screen 1600 by which device 100 can deliver messages to a worker. In some embodiments, a message includes a safety recommendation. Message tool 619 can supply, for example, messages from plant personnel or messages entered by client's safety department. In certain embodiments, message tool 619 requires acknowledgement by crew before moving on with the rest of the JSA review.

In certain embodiments, the invention includes, as message tool 619, a message app. The app can be triggered as part of the JSA review process. The message tool can provide the steps of requiring a worker to review, respond to, or acknowledge a message before the JSA review proceeds.

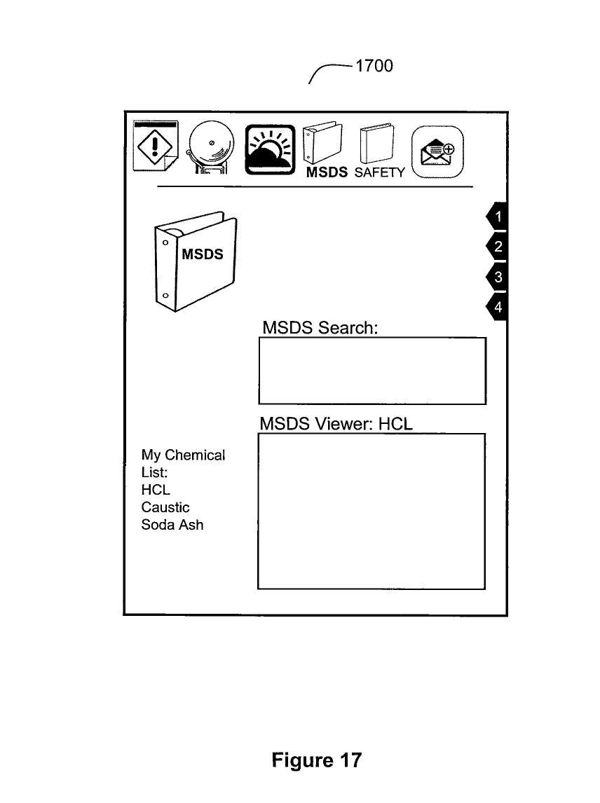

FIG. 17 shows an MSDS screen 1700 by which device 100 can deliver MSDS information to a worker. In some embodiments, MSDS information includes a safety recommendation. In certain embodiments, as part of the setup for a facility, unit or equipment, an MSDS list could be preset. In certain embodiments, the user could add an MSDS, for example with a look up tool for accessing the internet or server 310. In certain embodiments, the invention includes, as MSDS tool 615, an MSDS app. The app can be triggered as part of the JSA review process. The MSDS tool can require user interaction before the JSA review proceeds.

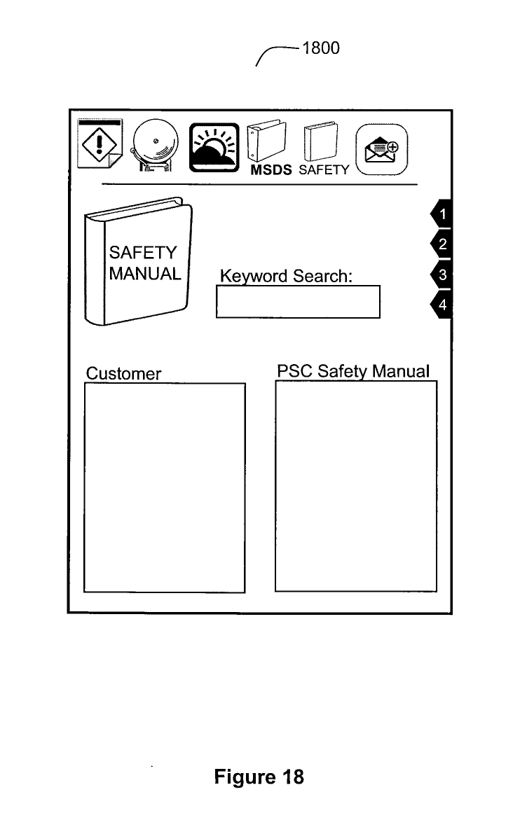

FIG. 18 shows a safety manual screen 1800 by which device 100 can deliver safety manual information to a worker. In some embodiments, safety manual information includes a safety recommendation. Safety manual tool 617 can have key word search, a customer manual, or s service provider or other manual. In certain embodiments, the invention includes, as safety manual tool 617, a safety manual app. The safety manual tool 617 can be triggered as part of the JSA review process.

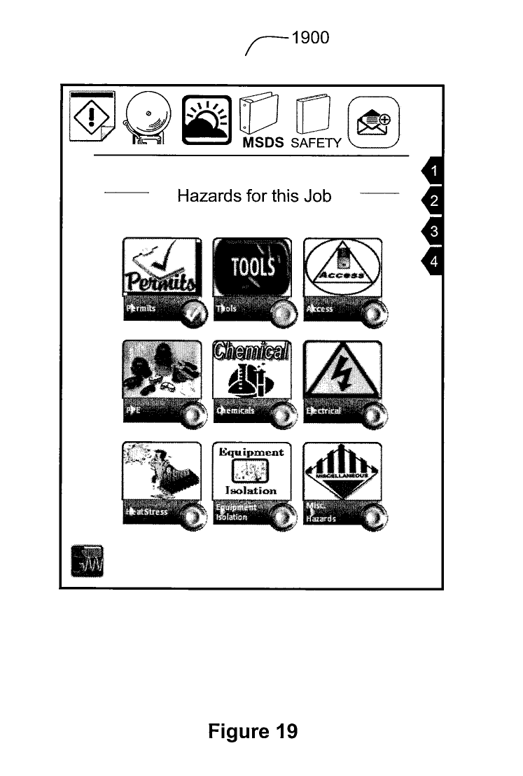

FIG. 19 shows a job hazard review screen 1900 by which device 100 can deliver job hazard information to a worker. The icons displayed on screen 1900 can represent categories of hazards associated with a job or a step of a job. Use of each icon can cause device 100 to display an associated hazard category screen 1500. When displaying hazard category screen 1500, device 100 can capture hazard information associated with a step of the job and deliver a safety recommendation relating to the hazard, for example, as a question structured to remind the worker of a safety practice, such as the importance of being licensed or the necessity of inspecting tools.

In certain embodiments, the invention provides customized forms associated with a JSA review. For example, in certain embodiments, a JSA review will be associated with certain groups or types of hazards. Examples of groups or types or categories of hazards according to the invention can include: permits; tools; access; PPE; chemicals; electrical; heat stress; equipment isolation; nuclear; public safety; repetitive steps; or miscellaneous. Customized forms can be setup to require completion of certain hazard groups. The hazard groups can be customizable. Each hazard group can be app based.

In certain embodiments, the invention includes a hazard app. The app can be triggered as part of the JSA review process. The hazard app can include one or more hazard groups. In an alternative embodiment, each hazard group is app-based.

In certain embodiments, voice recording is launched automatically when any portion of the analysis is conducted or when any app is opened.

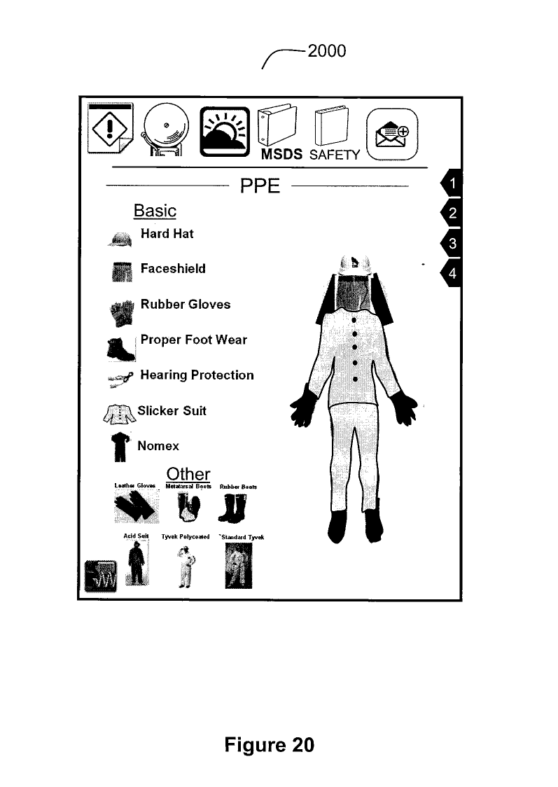

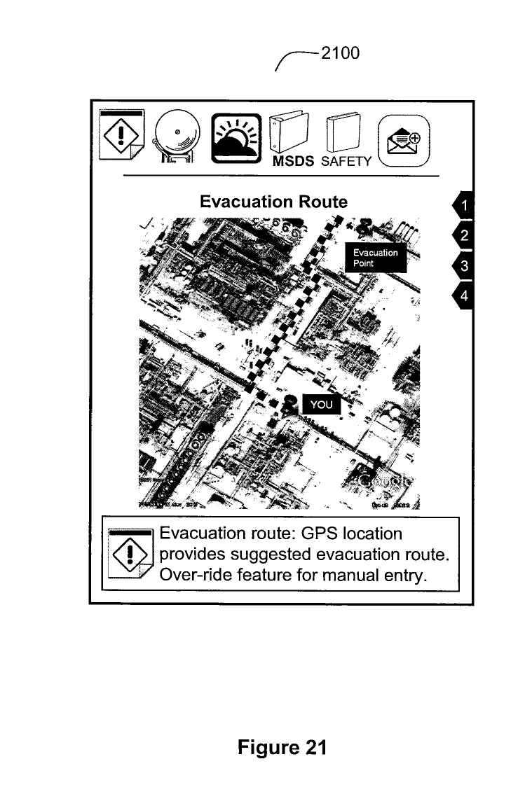

FIG. 20 shows a personal protective equipment screen 2000 by which device 100 can receive or deliver information about hazards or PPE recommended for a step of a job. In some embodiments, information about PPE includes a safety recommendation.

In certain embodiments, the invention includes a PPE app. The app can be triggered as part of the JSA review process. The PPE app can use the identity of a facility, unit, or equipment, if known, to present a PPE recommendation.

Examples of PPE include: hard hat; face shield; rubber gloves; proper foot wear; hearing protection; slicker suit; name; and other, including: leather gloves; metatarsal boots; rubber boots; acid suit; Tyvek poly-coated wear; standard Tyvek wear; braces; goggles; and medical information tags.

FIG. 21 shows an evacuation route screen 2100 by which device 100 can deliver evacuation route information to a worker. In some embodiments, evacuation route information includes a safety recommendation.

According to certain embodiments of the invention, ID device 370 is a GPS tag and each worker wears a GPS tag. According to certain embodiments of the invention, electronic files can be accessed via device 100. Electronic files may be stored on device 100, on a server 310, or on a client 350. Electronic files can include MSDS, job procedures, and safety manuals. According to certain embodiments, these electronic files are always available and multiple versions can be provided. According to certain embodiments of the invention, delivery of a safety recommendation includes information about a evacuation routes or a safety shower, for example, within the client's facility. This information can be recommended to a worker user based on GPS location.

In certain embodiments, a portable electronic device includes, as an input tool, a microphone. In one embodiment, a portable electronic device includes, as an output mechanism, a speaker or a headphone jack. In one embodiment, the invention provides a transcription module capable of transcribing audio recordings of speech into text. In one embodiment, the invention provides a translation module capable of translating text from one language to another. In one embodiment, the invention provides a read-aloud module capable of playing a text file aloud as speech.

In one embodiment, a portable electronic device includes, as an input tool, a digital camera. In one embodiment, a portable electronic device includes, as an input tool, a touch screen. In one embodiment, a portable electronic device includes, as an input tool, a keyboard. In one embodiment, a portable electronic device includes, as an output mechanism, a screen. In one embodiment, a portable electronic device includes, as an output mechanism, a printer. In one embodiment, a portable electronic device includes, as an input tool, a data connection configured to receive data from other devices or computers or networks. In one embodiment, a portable electronic device includes, as an output mechanism, a data connection, configured to send data to other devices or computers or networks. In one embodiment, a portable electronic device includes, as an input tool, a fingerprint scanner or sensor. In one embodiment, a portable electronic device includes, as an input tool, a GPS device. In one embodiment, a portable electronic device includes, as an input tool, a stylus or digital pen. In one embodiment, a portable electronic device includes, as an output mechanism, a noisemaker such as an alarm or alert bell.

It will be appreciated that devices according to the invention can be configured to capture information in the form of sound, for example, as human speech; touch, for example as touching icons on a screen; text, for example as typed in; text, for example as received through a data connection; text, for example as received as recorded speech and translated into text; images, for example as take by a digital camera; a fingerprint file; an image file or handwriting file, for example as captured by a stylus on a touch screen; GPS coordinates, for example as received as data or locally provided by a GPS device; text, for example as an image processed with optical character recognition; or other forms.

It will be appreciated that devices according to the invention can be configured to deliver information in the form of: sound, for example as a text file processed by read-aloud software; sound, for example as a sound file played through a speaker; images, for example as displayed on a screen; text, for example as displayed on a screen; text, for example as printed onto paper; or sound, for example as played through an alarm or alert bell.

In one embodiment of the invention, a worker contributes to the JSA review by speaking. Device 100 either prompts the worker to identify 450 hazards and suggest 458 recommendations or answer 518, 526 questions. The worker responds by speaking. A microphone of the invention records the speech and stores 454, 462, 530 the information in a data file. In one embodiment, the transcription module transcribes the worker's speech into text. In one embodiment, the translation module translates the text into another language.

In certain embodiments of the invention, the transcription module is supplied, for example by an application like Dragon Enterprise speech recognition software (Nuance Communications, Burlington, Mass.).

In one embodiment of the invention, both the sound file of the worker's speech and text file resulting from the transcription or translation step are appended to the JSA review file. In one embodiment, the invention delivers 474 recommendations to the workers by any of displaying text from the JSA review file on a screen, reading text from the JSA review file aloud, or playing back the sound recordings of the workers' spoken contributions to the review. In one embodiment, the JSA program includes the step of saving material to a JSA review file and copying the JSA review file to a database 328.

According to certain embodiments of the invention, forms may be customized during a portion of a JSA program. For example, a manager personnel may create a custom form using a manager client 350. Custom forms can be created, for example, using InfoPath, a web design tool-kit, or Microsoft Access, for example. Forms according to the invention can be promoted to device 100, for example, based on task and wor78098k area.

Systems and methods of the invention provide important tools for conducting a JSA program. Device 100 can provide prompts to stimulate hazard recognition. A JSA program can comprise one or more JSA reviews or JSA data files produced by a JSA review process. A JSA Program can provide hazard pattern information, which can be, for example, incorporated into JSA review forms. Systems and methods of the invention comprise electronic JSA data and storage thereof. Safety systems are discussed in U.S. Pat. No. 7,162,695 and U.S. Pub. 2008/0126150, the contents of which are hereby incorporated by reference in their entirety.

In certain embodiments, the invention comprises storing electronic JSA data in one or more data files 340 on one or more servers 310. The stored data can be made available, for example to managers to use in studying safety trends or evaluating or coaching employees. In certain embodiments, stored data is made available for reporting, for example to managers or to government safety agencies. Systems for safety analysis are discussed in U.S. Pat. No. 7,716,239; U.S. Pub. 2007/0150772; and U.S. Pub. 2004/0078098, the contents of each of which are hereby incorporated by reference in their entirety.

Systems and methods of the invention can provide metrics pertinent to a JSA program or JSA review. Metrics can include any data recorded, accessed, or stored by components of the invention or any data calculated by any component of the invention. For example, in certain embodiments, metrics include an amount of time spent on one or more JSA review and an average amount of time spent on JSA reviews, in total or broken down by workers or groups of workers.

In certain embodiments of the invention, devices of the invention measure or record data automatically. Methods and systems of the invention provide for the recording of JSA review data including, for example: a start time of a JSA; a completion time of a JSA; a time at which a worker accessed a device; a number of workers participating; the identities of workers participating; a number of or one or more identities of workers detected by ID device 370; a number of or one or more identities of workers not participating; an amount of time spent at each step of a JSA; an amount of new matter contributed to a data file; a size of a data file or a portion of a data file; an amount of time certain information is output or delivered by a system; an amount of data output or delivered by a system; an amount of data or amount of time of input into a system; or a record of which screens were accessed or interacted with—any of which can be metrics or the basis from which a metric can be derived. Data recorded by components of the invention can be stored and can allow metrics to be made pertinent to a JSA program or JSA review.

Systems and methods of the invention provide pre-programmed modules in analysis module 324, for example, which provide metrics. In certain embodiments, metrics are generated automatically or near automatically for the benefit of a person such as a manager. In certain embodiments, metrics are generated by one or more user interface (UI) actions such as a click of a mouse, or sent as files on a regular schedule.

In certain embodiments, GPS mechanics on a device 100 or associated with an ID device 370 can record metrics including a location at which a JSA review was completed. In certain embodiments, metrics include a comparison of a JSA review completion location to a job location.

In certain embodiments, the invention provides a reporting client 352 configured to generate or process metrics. In certain embodiments, analysis module 324 generates and process metrics or transmits metrics to reporting client 352.

Processing metrics can include identifying trends, analyzing trends, and spotting non-compliant events. In certain embodiments, metrics are processed in real-time.

A non-compliant event can include, for example: a JSA review being completed from, or not from, a job location; a worker proceeding to work on a job despite not completing a JSA review or having a status associated with permission to work; a JSA review being completed in too short or too long of an amount of time (i.e., indicating that a worker skipped through it quickly, or wandered off and ate lunch without participating in the process).

In certain embodiments of the invention, a non-compliant event is spotted in real-time (i.e., substantially simultaneously), and reported, for example, at reporting client 352.

In certain embodiments of the invention, device 100 records at least a portion of a conversation or talk including at least one worker and either stores the portion in a data file or transmits it to another device, for example, reporting client 352. Systems and methods of the invention provide the data file or the transmitted portion. For example, a manager can listen to conversation or talk, later or in real-time, thereby being exposed to a high level of detail, for example during an investigation. According to certain embodiments of the invention, a documented JSA conversation serves as powerful training tool for improving hazard recognition on the job.

The invention provides systems, methods, and apparatus which can allow anyone to use the JSA platform. In certain embodiments, an ID device 370 can identify a person. In certain embodiments, a person who uses the invention has a user profile, which can include personalized data. In certain embodiments, when a new user uses systems of the invention, a profile is optionally created for that user, and any identifying information can optionally be captured.

A user profile of the invention comprises user data. According to certain embodiments of the invention, user data includes: the user's company; the user's job title; the user's areas of licensure, training, or expertise; the user's history; the user's craft; or a password.

Custom forms can be presented on device 100 that take into account user data, for example from the user profile. In one illustrative embodiment, a service provider supplies one or more devices 100 to one or more different work crews before the start of a complex, multi-step job. Workers staffed to the job include workers from one or more different sub-contractor companies. A worker access one of device 100 and provide unique identifying information, for example through ID device 370. Device 100 accesses the user's profile and recognizes that the worker is employed by subcontractor A or that the worker is certified to use machine B. Device 100 then presents a customized screen, for example, a variant of screen 1400, presenting the worker with a list of questions specific to subcontractor A or machine B.

In certain embodiments of the invention, tools of the invention provide information or influence the JSA review. For example, in certain embodiments, weather tool 613 allows a worker to access a current weather report, a historical weather condition, a weather prediction, or a required weather condition. In certain embodiments, a step of a JSA review requires the worker to access a tool. In certain illustrative embodiments, a step of the invention requires a worker to access a current weather condition, for example as supplied by an outside web site. In certain embodiments, a step of a JSA will only proceed if a satisfactory condition is obtained. For example, if a job involves certain conditions, a JSA review may only proceed if a worker accesses weather information indicating cool and dry outdoor conditions. In certain embodiments, weather tool 613 simply provides information, i.e., ice and snow. Similarly, tools of the invention can, in certain embodiments, provide workers with valuable information-gathering tools, such as web-browsing or email functions, or running third-party commercial software applications.

Systems of the invention can include one or more computer, electronic computing device, or server, i.e., computer-based machined containing a set of instructions for causing the machine to perform any one or more of the methodologies discussed herein. An electronic computing device, computer, or server may operate as a standalone device or may be connected (e.g., networked) to other machines. In a networked deployment, these machines may operate in the capacity of a server or a client machine in server-client network environment, or as a peer machine in a peer-to-peer (or distributed) network environment. For example, in certain embodiments, any of a database, data file, or interface tools are on portable electronic devices.

In various embodiments, machines of the invention can be, as necessary to perform the methodologies described herein, a personal computer (PC), a tablet PC, a laptop, an iPad, a set-top box (STB), a personal digital assistant (PDA), a cellular telephone, a smart phone, a web appliance, a network router, switch or bridge, or any machine capable of executing a set of instructions (sequential or otherwise) that specify actions to be taken by that machine. Further, the term “machine” can include any single device or collection of machines that individually or jointly execute a set (or multiple sets) of instructions to perform any one or more of the methodologies discussed herein.

As one skilled in the art would recognize as necessary or best-suited for performance of the methods of the invention, computer systems or machines of the invention include one or more processors (e.g., a central processing unit (CPU) a graphics processing unit (GPU) or both), a main memory and a static memory, which communicate with each other via a bus. Computer systems or machines according to the invention may further include a video display unit (e.g., a liquid crystal display (LCD) or a cathode ray tube (CRT)). Computer systems or machines according to the invention can also include an alphanumeric input device (e.g., a keyboard), a cursor control device (e.g., a mouse), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, or cellular modem.

A disk drive unit according to the invention can include a machine-readable medium on which is stored one or more sets of instructions embodying any one or more of the methodologies or functions described herein. The software may also reside, completely or at least partially, within the main memory and/or within the processor during execution thereof by the computer system, the main memory and the processor also constituting machine-readable media. Exemplary systems and system architectures for use with the invention are described in U.S. Pub. 2011/0209133, U.S. Pub. 2011/0175923, and U.S. Pub. 2007/0112800, each of which is incorporated by reference herein in its entirety. Software may further be transmitted or received over a network via a network interface device.

While the machine-readable medium can in an exemplary embodiment be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories (e.g., subscriber identity module (SIM) card, secure digital card (SD card), or micro SD card, flash memory, SSD drives, etc.), optical and magnetic media (e.g., hard drives), and any other tangible storage media.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A system for ensuring safety, the system comprising:
a portable electronic device containing a memory, the device being configured to capture information that uniquely identifies a person and further comprising:
a data file, stored in the memory, containing information identifying a first step of a job to be performed;
an input tool configured to capture hazard information associated with the first step of the job and store the hazard information in the data file; and
an output mechanism operably engaged with the portable electronics device and configured to deliver a safety recommendation relating to the hazard.

2. The system of claim 1 further comprising:
a database communicatively coupled to the memory, the database being configured to receive and save data from the data file and additional data from a second data file; and
a computer processor operably engaged with the database and configured to analyze the saved data and the saved additional data and produce an output file comprising a hazard pattern.

3. The system of claim 1 further comprising:
a second device configured to receive alert information and substantially immediately transmit the alert information to the portable electronic device, and
wherein the portable electronic device is further configured to report the alert information to the person.

4. The system of claim 2 wherein the computer processer is further configured to provide a metric associated with the capturing of information by the portable electronics device.

5. The system of claim 4 wherein the metric comprises one selected from the lists consisting of: an duration of a process; an identity of a participant; a size of a portion of the data file; a time of a computer interaction; a location of a computer interaction; information about a non-compliant event; and an estimated cost associated with one or more JSA reviews.

6. The system of claim 1 further comprising a personnel tag uniquely associated with the person and wherein the portable electronic device is further configured to electronically determine a location of the personnel tag.

7. The system of claim 8 wherein the output mechanism is one selected from the list consisting of a speaker, a screen, and a noisemaker.

9. The system of claim 1, wherein the portable electronic device further comprises a status indicator configured to:
indicate a status of the person; and
change, responsive to the output mechanism delivering the safety recommendation, the status of the person.

10. The system of claim 1, wherein the input tool comprises a camera configured to capture an image of a hazard.

11. The system of claim 1 further comprising a second portable electronics device and at least one communication module, wherein the communication module is configured to send part of the data file from the portable electronic device to the second portable electronic device.

12. The system of claim 1 wherein the data file further comprises information identifying a second step of a job to be performed.

13. A method for ensuring safety, the method comprising performing, by means of a computer system, the steps of:
providing a portable electronic device at a site where a job is to be performed, the portable electronics device comprising a memory, the memory comprising a data file;
recording, in the memory, information that uniquely identifies a person at the site where a job is to be performed;
capturing hazard information associated with a first step of the job to be performed;
saving the hazard information in the data file; and
delivering, by means of the portable electronic device, a safety recommendation relating to the hazard to the person at the job site.

14. The method of claim 13, further comprising the steps of:
transferring data from the data file to a database;
transferring additional data from a second data file to the database; and
analyzing, using a computer processor in communication with the database, the data and the additional data to produce an output file comprising a hazard pattern.

15. The method of claim 13 wherein the capturing step further comprises receiving and storing one selected from the list consisting of: keyboard strokes; a digital picture, a fingerprint image, touch-screen input data, accelerometer input data, and a sound recording of human speech.

16. The system of claim 13 wherein the delivering step comprises one selected from the list consisting of: playing sound through a speaker, displaying data on a screen, and playing a noise using a noisemaker.

17. The method of claim 13, further comprising the steps of:
indicating a status of the person by means of the portable electronic device; and
changing, after recording the information that uniquely identifies a person, the status of the person.

18. The method of claim 13 further including the steps of:
establishing a review status;
setting the review status to incomplete; and
changing, only after one or more of the other steps is complete, the review status to complete.

19. The method of claim 13 further including the steps of:
capturing an image of a hazard using a camera operably coupled to the computer system.

20. The method of claim 13, wherein the delivering a safety recommendation step further comprises the steps of:
accessing a text string stored in the data file;
converting the text string into a sound of human language corresponding to the text string.

21. An apparatus containing a memory and configured to capture information that uniquely identifies a person and further comprising:
a data file, stored in the memory, containing information identifying a first step of a job to be performed and information identifying a second step of a job to be performed;
an input tool configured to capture hazard information associated with the first step of the job and store the hazard information in the data file; and
an output mechanism configured to deliver a safety recommendation relating to the hazard.

22. The apparatus of claim 21 further comprising a data transfer mechanism configured to send data to a database.

23. The apparatus of claim 21, further comprising a data transfer mechanism configured to send part of the data file to a portable electronic device.

24. The apparatus of claim 21, further comprising one or more apps configured to communicate information pertaining to a hazard.

25. The apparatus of claim 21, wherein the output mechanism comprises a speaker, and further comprising a read aloud program configured to convert a text string into a sound of language corresponding to the text string.

26. The apparatus of claim 21, wherein the input tool is further configured to:
capture a hazard recommendation associated with a first step of the job to be performed; and
store the hazard recommendation in the data file.
